(19) United States
(12) Patent Application Publication
(10) Pub. No.: US 2014/0242537 A1
(43) Pub. Date: Aug. 28, 2014

(54) STERILE PTFE STRIPS WITH APPLICATION TAB

(71) Applicants: Kyle STANLEY, Los Angeles, CA (US); Charles ODION, Springfield, PA (US)

(72) Inventors: Kyle STANLEY, Los Angeles, CA (US); Charles ODION, Springfield, PA (US)

(21) Appl. No.: 14/189,364

(22) Filed: Feb. 25, 2014

Related U.S. Application Data
(60) Provisional application No. 61/769,483, filed on Feb. 26, 2013.

(51) Int. Cl. A61C 5/12

(52) U.S. Cl. CPC A61C 5/12
USPC 433/25

(57) ABSTRACT

A dental treatment apparatus is disclosed that may include a PTFE strip and at least one applicator tab attached to the PTFE strip wherein the applicator tab can be pulled away from the PTFE strip under the discretion of an operator. The applicator tab may comprise at least one adhesive surface limited to an area of the application tab which is used for attaching the application tab to the PTFE strip. The PTFE strip and the applicator tab may comprise varying shapes, widths, and lengths based on its desired application.

### CROSS REFERENCE TO PRIOR APPLICATION

This application claims priority to and the benefit thereof from U.S. provisional patent application No. 61/769,483, filed Feb. 26, 2013, titled “Sterile PTFE Strips with Application Tab,” the entirety of which is hereby incorporated herein by reference.

### FIELD OF THE INVENTION

The invention relates generally to a strip for use in dental care, and more specifically it relates to a sterile polytetrafluoroethylene (PTFE) strips and/or sterile PTFE strips with an application tab.

### BACKGROUND OF THE INVENTION

Polytetrafluoroethylene (PTFE) is commonly sourced for dental procedures as Teflon plumbing tape, such as obtained, e.g., from a hardware store. When PTFE is used from this source, it is cut and handled from a role of Teflon tape. As an example, as a dental assistant and dentist reuse this role of Teflon from patient to patient the Teflon role itself becomes susceptible to contamination and subsequent cross contamination of microbes to other patients as the frequency of its use increases. Subsequently, dentists wear gloves ranging from latex, vinyl, and nitrile to avoid potential contamination to the Teflon role. These gloves make the handling of 2″-5″ pieces of ½″ of Teflon tape cumbersome for the dentist. Additionally, once a piece is cut from the role of Teflon plumbers tape, it is difficult to handle and subsequently use in its applications for a dentist.

There is an unfulfilled need for an apparatus that enhances ease of use and handling of PTFE and at the same time, minimize cross contamination between patients.

### SUMMARY OF THE INVENTION

In one aspect of this disclosure, a PTFE strip and/or an application tab are provided for improving PTFE handling in dental procedures.

In one aspect, a dental treatment apparatus includes a PTFE strip and at least one applicator tab attached to the PTFE strip wherein the applicator tab can be pulled away from the PTFE strip under the discretion of an operator. The applicator tab may comprise at least one adhesive surface limited to an area of the application tab which is used for attaching the application tab to the PTFE strip. The applicator tab may comprise a plastic, a fabric, or paper based products. The PTFE strip and the applicator tab may comprise varying shapes, widths, and lengths based on its desired application. The PTFE strip may be configured to extend past the attached applicator tab for easier handling by the operator. The applicator tab may be configured to extend past the attached PTFE strip for easier handling by the operator. The PTFE strip may be sandwiched between multiple applicator tabs. The applicator tabs may be inversely aligned to have the adhesive portions of the applicator tab on opposite ends of the PTFE strip. The applicator tabs may be aligned to have the adhesive portions of the applicator tab on same ends of the PTFE strip.

In one aspect, a dental treatment apparatus is provided that includes a PTFE strip, at least one applicator tab attached to the PTFE strip and a sterile package. The PTFE strip and the attached applicator tab may be stored inside the sterile package. The sterile package may comprise at least one layer of sealable material that is sealed by adhesives. The applicator tab may comprise at least one adhesive surface limited to an area of the applicator tab which is used for attaching the applicator tab to the PTFE strip. The applicator tab may comprise a plastic, a fabric, or paper based products. The PTFE strip and the applicator tab may comprise varying shapes, widths, and lengths based on the desired application of the apparatus. The strip may be configured to extend past the attached applicator tab for easier handling by the operator. The applicator tab may be configured to extend past the attached PTFE strip for easier handling by the operator. The PTFE strip may be sandwiched between multiple applicator tabs. The applicator tabs may be inversely aligned to have the adhesive portions of the applicator tab on opposite ends of the PTFE strip. The adhesive portions of the applicator tab may be on same ends of the PTFE strip.

### BRIEF DESCRIPTION OF THE DRAWINGS

The accompanying drawings which are included to provide a further understanding of the invention, are incorporated in and constitute a part of this specification, illustrate embodiments of the invention and together with the detailed description serve to explain the principles of the invention. No attempt is made to show structural details of the invention in more detail than may be necessary for a fundamental understanding of the invention and the various ways in which it may be practiced. In the drawings:

FIG. 1 shows an example of PTFE strip being adhered, for packaging, to the applicator tab in accordance with the principles of the disclosure.

FIG. 2 shows an example of a sterile packaging which will house the PTFE strip with the applicator tab in accordance with the principles of this disclosure.

FIG. 3 shows an example of a PTFE strip with the applicator tab being handled by the operator once it has been removed from its sterile packaging in accordance with the principles of this disclosure.

FIG. 4 shows an example of PTFE strip with two applicator tabs in accordance with the principles of this disclosure.

FIG. 5 shows an example of PTFE strip with two applicator tabs being applied to a desired object in accordance with the principles of this disclosure.

FIG. 6 shows an example of PTFE strip applied to a desired object with two applicator tabs being pulled away in accordance with the principles of this disclosure.

FIG. 7 shows an example of a completed process of the PTFE strip secured on a desired Object and the applicator tabs removed from the PTFE strip in accordance with the principles of this disclosure.

### DETAILED DESCRIPTION OF THE INVENTION

The embodiments of the invention and the various features and advantageous details thereof are explained more fully with reference to the non-limiting embodiments and examples that are described and/or illustrated in the accompanying drawings and detailed in the following attached description. It should be noted that the features illustrated in the drawings are not necessarily drawn o scale, and features of one embodiment may be employed with other embodiments as the skilled artisan would recognize, even if not explicitly stated herein. Descriptions of well-known components and processing techniques may be omitted so as to not unnecessarily obscure the embodiments of the invention. The examples used herein are intended merely to facilitate an understanding of ways in which the invention may be practiced and to further enable those of skill in the art to practice the embodiments of the invention. Accordingly, the examples and embodiments herein should not be construed as limiting the scope of the invention, which is defined solely by the appended claims and applicable law. Moreover, it is noted that like reference numerals represent similar parts throughout the several views of the drawings.

The terms “including”, “comprising” and variations thereof, as used in this disclosure, mean “including, but not limited to”, unless expressly specified otherwise.

The terms “a”, “an”, and “the”, as used in this disclosure, means “one or more”, unless expressly specified otherwise.

Although process steps, method steps, or the like, may be described in a sequential order, such processes and methods may be configured to work in alternate orders. In other words, any sequence or order of steps that may be described does not necessarily indicate a requirement that the steps be performed in that order. The steps of the processes or methods described herein may be performed in any order practical. Further, some steps may be performed simultaneously.

When a single device or article is described herein, it will be readily apparent that more than one device or article may be used in place of a single device or article. Similarly, where more than one device or article is described herein, it will be readily apparent that a single device or article may be used in place of the more than one device or article. The functionality or the features of a device may be alternatively embodied by one or more other devices which are not explicitly described as having such functionality or features.

An aspect of the disclosure includes a novel sterile PTFE strip with one or more application tabs. The invention may be used in, for example, the dental field.

According to a further aspect of the disclosure, a design of the PTFE strip with an application tab includes an application tab and a PTFE backer that serve to enhance the PTFE strip handling. The application tab may be made of a material that provides reinforcing support to the PTFE e.g., a paper, a plastic, a fabric, a metal, a carbon fiber, and the like. A section of the applicator tab that is in contact with the PTFE may further include an adhesive product to allow the PTFE to adhere to the tab as it is handled. The adhesive may be e.g., glue, cement, mucilage, paste, bond or any other adhesive chemical, bioadhesive, and the like.

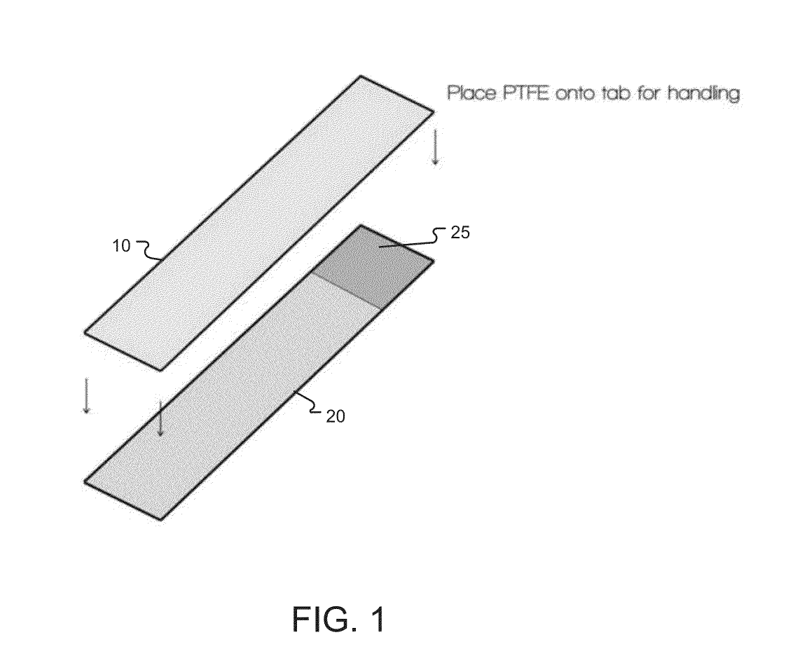

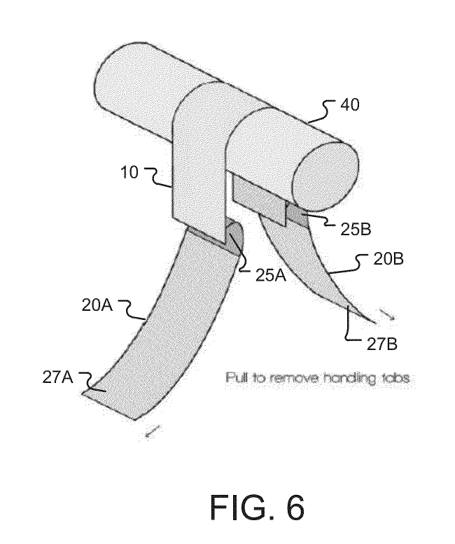

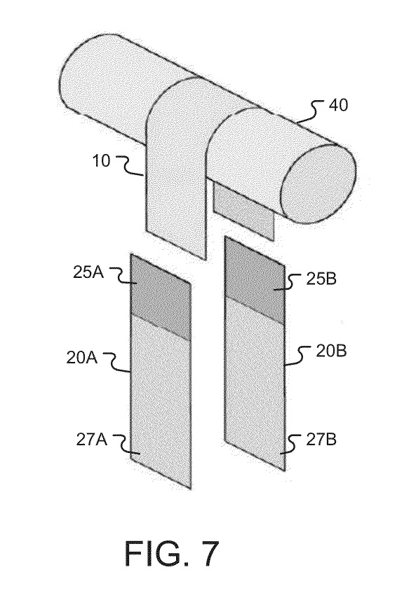

As seen in FIGS. 1-7, the exemplary designs of the present disclosure solve the concern of cross contamination of microbes among patients. The designs may be reinstituted from rolls to individual packets housed in sterile environment similar to, for example, the packaging used in first aid bandages.

FIG. 1 shows an example of a PTFE strip adhered to an applicator tab that is constructed according to the principles of this disclosure. Reaming to FIG. 1, a PTFE strip 10 may be adhered to an applicator tab 20 for, e.g., handling, application, packaging, carrying, storing, and the like. The PTFE strip 10 may include various geometric shapes (e.g., circular, triangular, rectangular, pentagon, and so on) and sizes based on its purpose and/or object to be applied onto. The adhesive 25 is a portion of the applicator tab 20 that may hold the PTFE strip 10 together with the applicator tab 20 during application of PTFE strip 10 onto a desired object (e.g., a tooth or other body parts, watch, shoe, valve, door handle, and the like). The adhesive may be placed at the end of the applicator tab and/or other areas of the tab as appropriate. The end portion of the applicator tab 20 may grasped by an operator. The end portion of the applicator tab 20 may further be configured to extend beyond the edge of the PTFE strip 10 so that it may be grasped by, e.g., the operator's fingers, without contacting the PTFE strip 10. The PTFE strip 10 may be applied directly onto a desired area of an object following or during the removal of the applicator tab 20.

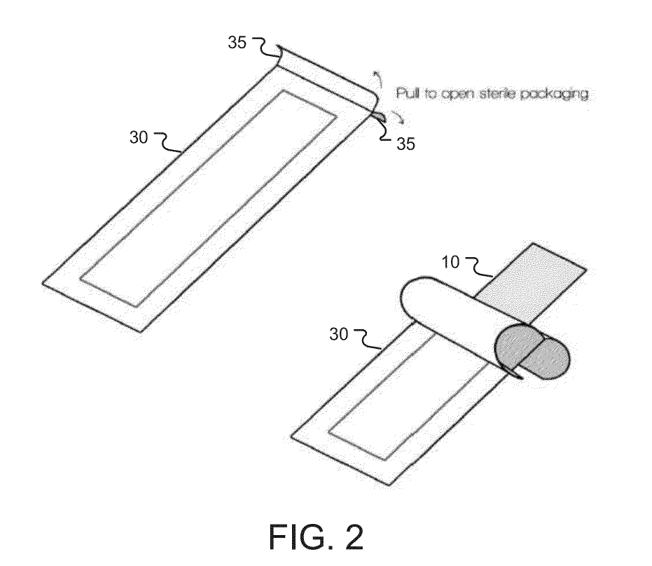

FIG. 2 shows an example of a PTFE strip that is stored within a sterile package in accordance with the principles of this disclosure. As seen in FIG. 2, a PTFE strip 10 with and/or without an adhering applicator(s) tab 20 (not shown) may be contained iii a sterile package 30. The sterile package 30 may further include multiple (e.g., two) layers that sandwich and/or seal the PTFE strip 10 between them. Alternatively, sterile package 30 may include one continuous sealable package that can be opened from either ends or sides.

The layers of sterile package 30 may include any sealable materials (e.g., paper, plastic, rubber, metal, carbon fiber, silk and the like) and be sealed or affixed to each other by e.g., glue, bond, adhesive, chemical, thread, screw, clamp, and the like. The sterile package 30 may include an end portion 35 that can be grasped by, e.g., an operator's fingers or a grasping tool, without contacting the PTFE strip 10. The operator may grasp one and/or both end portion(s) 35 with e.g., a hand, and pull the end portion(s) 35 apart to expose the PTFE strip 10 with the adhering applicator(s) tab 20.

Alternatively, the package 30 may only contain the PTFE strip 10 which may then be applied directly onto a desired object. Afterwards, the layers of the package 30 may be peeled away (or opened) to leave PTFE strip 10 secured onto the object.

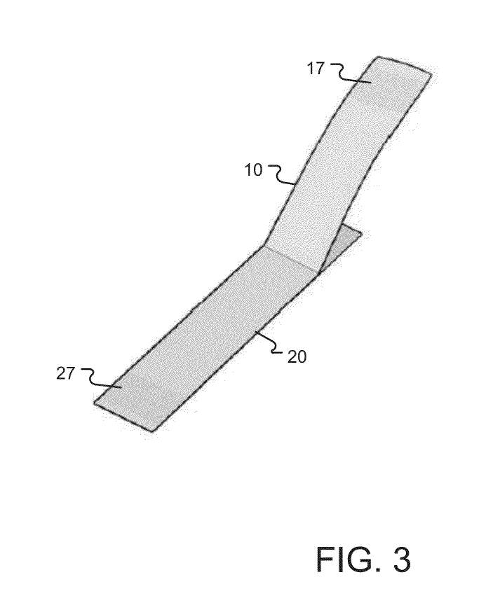

FIG. 3 illustrates an example of a PTFE strip 10 adhered to an applicator tab 20 being handled by an operator in accordance with the principles of the disclosure. The applicator tab 20 may include an end portion 27 which can be grasped by an operator. The end portion 27 may also be configured to extend beyond the edges of the PTFE strip 10 when adhered to PTFE strip 10. This makes it possible for the operator to grasp the tab 20 without contacting the PTFE strip 10. The operator may grasp tab end 27 with one hand and pull apart to expose the PTFE strip 10.

Alternatively, the PTFE strip 10 may include an end portion 17 that can be grasped by the operator. The end portion 17 may be configured to extend beyond the edges of the tab 20 when adhered to tab 20. This makes it possible for the operator to grasp PTFE strip 10 by grabbing the end portion 17 and thereby easily handle the PTFE strip 10.

In a case of multiple applicator tabs 20, the grasp-able tab ends 27 may be configured at opposite ends of the PTFE strip 10, near the edges of the PTFE strip 10, but positioned such that each applicator tab end may be grasped by the operator's fingers simultaneously and pulled apart to expose the PTFE strip. Alternatively, the edge of one or both of the tab ends 27 may be substantially aligned with and proximate to an edge of the PTFE strip.

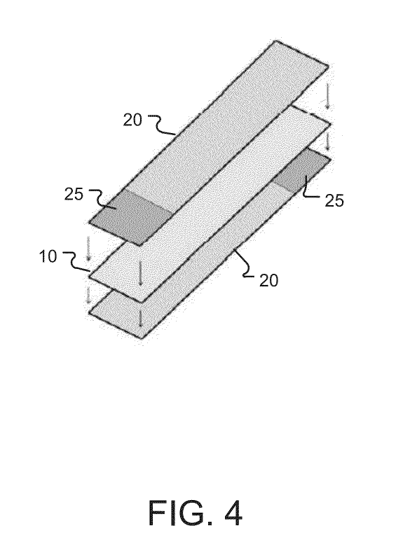

FIG. 4 shows an example of an exploded view of a PTFE strip 10 that is sandwiched between a pair of applicator tabs 20 and how the structure may be assembled in accordance to the principles of this disclosure. As seen in FIG. 4, the invention may include multiple (e.g., two) applicator tabs 20. The applicator tabs 20 may be identical but flipped to have adhesive portions 25 attached to opposing sides of the PTFE strip, with one on the top and the other on the bottom. As previously described, end portions of the tabs 20 may be configured to extend past the PTFE strip 10 so that it can be easily grasped and handled by an operator. Alternatively, the end portions of the PTFE strip 10 may be configured to extend past the applicator tab 20.

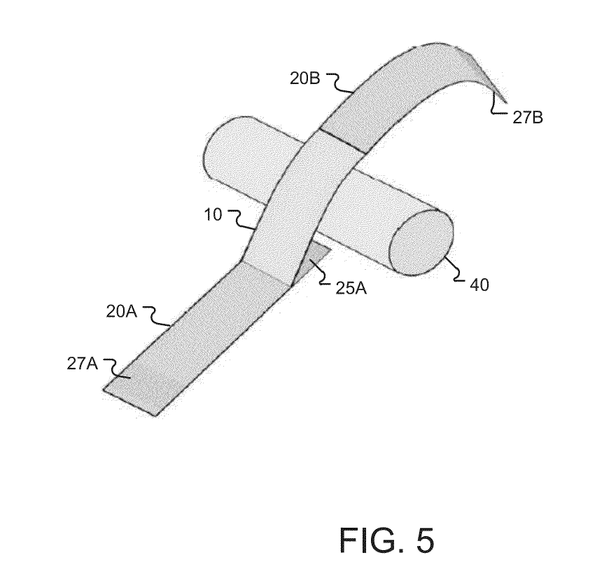

FIGS. 5-7 show an example of an application of a PTFE strip 10 according to the principles of this disclosure. As seen in FIG. 5, after the PTFE strip 10 with application tabs 20A-B are removed from their package (if provided in a package), an operator may be able to manipulate and apply the PTFE strip 10 with ease to a desired object 40 by grasping an end portion 27A of a first applicator tab 20A and an end portion 27B of a second applicator tab 20B, aligning the PTFE strip 10 to a desire position, and affixing or contacting the PTFE strip 10 on or to a desired location on the object 40.

Referring to FIG. 5-7 concurrently, the applicator tabs 20A and 209 may be pulled to firmly secure the PTFE strip 10 to the object 40 and further peel away the applicator tabs 20A-B from the PTFE strip 10. An operator may pull the applicator tabs 20A and 20B away from the secured PTFE strip 10 simultaneously. As shown, the adhesive portions 25A and 25B keeps the applicator tabs 20A and 20B attached to the PTFE strip 10 until it is completely peeled off. The operator will not have to handle the PTFE strip 10 during both the placement and removal of the applicator tabs 20A and 20B. The process may be completed by having the PTFE strip 10 secured to an object 40 and then pulling on the applicator tabs 20A and 20B until the applicator tabs 20A and 20B are completely removed from the PTFE strip 10. This results in PTFE strip 10 firmly secured to the object 40. This also allows handling of PTFE strip 10 by the operator without potential contamination since the operator avoids direct contact with PTFE strip 10.

While the invention has been described in terms of exemplary embodiments, those skilled in the art will recognize that the invention can be practiced with modifications in the spirit and scope of the appended claims. These examples given above are merely illustrative and are not meant to be an exhaustive list of all possible designs, embodiments, applications or modifications of the invention.

What is claimed:

1. A dental treatment apparatus comprising:
a PTFE strip; and
at least one applicator tab attached to the PTFE strip wherein the applicator tab can be pulled away from the PTFE strip under the discretion of an operator.

2. The dental treatment apparatus according to claim 1 wherein the applicator tab comprises at least one adhesive surface limited to an area of the application tab which is used for attaching the application tab to the PTFE strip.

3. The dental treatment apparatus according to claim 1 wherein the applicator tab comprises a plastic, a fabric, or paper based products.

4. The dental treatment apparatus according to claim 1 wherein the PTFE strip and the applicator tab comprise varying shapes, widths, and lengths based on its desired application.

5. The dental treatment apparatus according to claim 1 wherein the PTFE strip is configured to extend past the attached application tab for easier handling by the operator.

6. The dental treatment apparatus according to claim 1 wherein the applicator tab is configured to extend past the attached PTFE strip for easier handling by the operator.

7. The dental treatment apparatus according to claim 1 wherein the PTFE strip is sandwiched between multiple applicator tabs.

8. The dental treatment apparatus according to claim 7 wherein the applicator tabs are inversely aligned to have the adhesive portions of the applicator tab on opposite ends of the PTFE strip.

9. The dental treatment apparatus according to claim 8 wherein the applicator tabs are aligned to have the adhesive portions of the applicator tab on same ends of the PTFE strip.

10. A dental treatment apparatus comprising:
a PTFE strip;
at least one applicator tab attached to the PTFE strip; and
a sterile package.

11. The dental treatment apparatus according to claim 10 wherein the PTFE strip and the attached applicator tab are stored inside the sterile package.

12. The dental treatment apparatus according to claim 10 wherein the sterile package comprises at least one layer of sealable material that is sealed by adhesives.

13. The dental treatment apparatus according to claim 10 wherein the applicator tab comprises at least one adhesive surface limited to an area of the applicator tab which is used for attaching the applicator tab to the PTFE strip.

14. The dental treatment apparatus according to claim 10 wherein the applicator tab comprises a plastic, a fabric, or paper based products.

15. The dental treatment apparatus according to claim 10 wherein the PTFE strip and the applicator tab comprise varying shapes, widths, and lengths based on the desired application of the apparatus.

16. The dental treatment apparatus according to claim 10 wherein the PTFE strip is configured to extend past the attached applicator tab for easier handling by the operator.

17. The dental treatment apparatus according to claim 10 wherein the applicator tab is configured to extend past the attached PTFE strip for easier handling by the operator.

18. The dental treatment apparatus according to claim 10 wherein the PTFE strip is sandwiched between multiple applicator tabs.

19. The dental treatment apparatus according to claim 18 wherein the applicator tabs are inversely aligned to have the adhesive portions of the applicator tab on opposite ends of the PTFE strip.

20. The dental treatment apparatus according to claim 19 wherein the applicator tabs are aligned to have the adhesive portions of the applicator tab on same ends of the PTFE strip.
